(19) United States
(12) Patent Application Publication
(10) Pub. No.: US 2005/0220396 A1
(43) Pub. Date: Oct. 6, 2005

(54) Multi-channel drop filter using photonic crystal

(76) Inventors: Chul Sik Kee, Daejeon-shi (KR); Sang Pil Han, Daejeon-shi (KR); Choon Gi Choi, Daejeon-shi (KR); Keun Byoung Yoon, Daejeon-shi (KR)

Correspondence Address: MAYER, BROWN, ROWE & MAW LLP, 1909 K STREET, N.W., WASHINGTON, DC, 20006, US

(21) Appl. No.: 11/020,112

(22) Filed: Dec. 27, 2004

(30) Foreign Application Priority Data
Apr. 6, 2004 (KR) 2004-23303

(51) Int. Cl. G02B 6/10; G02B 6/28

(52) U.S. Cl. 385/24; 385/15; 385/39; 385/129

(57) ABSTRACT

Provided is a multi-channel drop filter using a photonic crystal, wherein light having a desired wavelength among light of various wavelengths guided along a bus wavelength is filtered to the drop waveguide arranged perpendicular to the bus waveguide through a resonator arranged between the bus and drop waveguides, thereby being easily connected to the existing planar photonic crystal devices to enable fabrication by nanoimprint technology using an embossing process as well as implementing an optical filter having an ultra narrowband line width and a high integrated photonic integrated circuit.

### CROSS-REFERENCE TO RELATED APPLICATION

This application claims priority to and the benefit of Korean Patent Application No. 2004-23303, filed on Apr. 6, 2004, the disclosure of which are incorporated herein by reference in its entirety.

### BACKGROUND

1. Field of the Invention

The present invention relates to a multi-channel drop filter using a photonic crystal and, more specifically, to a multi-channel drop filter using a photonic crystal capable of being easily connected to an existing planar photonic crystal device and implementing an optical filter having an ultra narrowband line width and a high-density photonic integrated circuit, by forming a plurality of output waveguides, i.e., drop waveguides in a direction perpendicular to and near an input waveguide, i.e., a bus waveguide formed by a line defect within the photonic crystal as well as forming at least one resonator by a point defect between the bus waveguide and the drop waveguide.

2. Discussion of Related Art

In general, dense wavelength division multiplexing (hereinafter, referred to as ‘DWDM’) technology requires an optical filter and a switch having an ultra narrowband line width of a sub-nanometer channel interval.

However, the conventional optical technology has a limitation in fulfilling the requirements in terms of performance and size of device. Therefore, there is a need for a new concept of optical device.

Further, photonic crystal technology has proposed breakthrough solutions with which the existing optical device can be reduced to several micrometers as well as the performance of the optical device is improved. Using a photonic band gap (PBG), which is the typical optical properties of the photonic crystal, a highly efficient light source, a highly stable light source having an ultra narrowband wavelength, an ultra small optical interconnection, ultra narrowband integrated type and highly selective optical filter and switch can be implemented. Recently, it has been proved that the high-density photonic integrated circuits can be implemented.

The related patent (U.S. Pat. No. 6,130,969 (Oct. 10, 2000), WO9857207) entitled to “High efficient channel drop filter” is directed to a drop filter using a photonic crystal, where a bus waveguide and a drop waveguide due to line defects in the planar type photonic crystal are formed side by side, and a resonator fabricated by point defects is arranged between them for filtering, and two resonators are required for each wavelength.

However, in the afore-mentioned structure, the dropped light is guided along with the same drop waveguide so that it is not appropriate to the device such as DWDM, which should independently deal with the dropped light having different wavelengths from each other.

In addition, a drop phenomenon may occur only when the two resonators between the bus and drop waveguides have the same structure. Therefore, there is a problem in that fabrication should be made in high precision.

### SUMMARY OF THE INVENTION

The present invention is directed to a multi-channel drop filter using a photonic crystal capable of being easily connected to the existing planar photonic crystal devices to enable fabrication by nanoimprint technology using an embossing process as well as implementing an optical filter having an ultra narrowband line width and a high integrated photonic integrated circuit, by forming a plurality of drop waveguides in a direction perpendicular to and near a bus waveguide formed by line defects within a photonic crystal as well as forming at least one resonator by point detects between the bus and drop waveguides to filter light having a desired wavelength among light of various wavelengths guided along the bus wavelength to the drop waveguide arranged perpendicular to the bus waveguide through the resonator arranged between the bus and drop waveguides.

According to an aspect of the present invention, there is provided a multi-channel drop filter using a photonic crystal comprising: a bus waveguide formed in a photonic crystal; at least one drop waveguide arranged perpendicular to the bus waveguide; and at least one resonator arranged between the bus waveguide and the drop waveguide to independently filter light having a desired wavelength among light of various wavelengths guided along the bus waveguide to the desired drop waveguide.

The bus waveguide and the drop waveguide are preferably formed by line defects.

The resonator is preferably formed by point defects

### BRIEF DESCRIPTION OF THE DRAWINGS

The foregoing and other objects, features and advantages of the invention will be apparent from the more particular description of a preferred embodiment of the invention, as illustrated in the accompanying drawing. The drawing is not necessarily to scale, emphasis instead being placed upon illustrating the principles of the invention:

FIG. 1 is a schematic diagram illustrating a multi-channel drop filter using a photonic crystal according to an embodiment of the present invention;

FIG. 2 is a diagram illustrating a two-channel drop filter using a photonic crystal according to an embodiment of the present invention; and

FIG. 3 is a diagram illustrating reflection and transmission characteristics of a bus waveguide and transmission characteristics of a drop waveguides in a two-channel drop filter using a photonic crystal according to an embodiment of the present invention.

### DETAILED DESCRIPTION OF PREFERRED EMBODIMENTS

Exemplary embodiments of the present invention will now be described in detail with reference to the accompanying drawings. However, the present invention is just illustrative, and should not be construed as limiting the scope of the present invention.

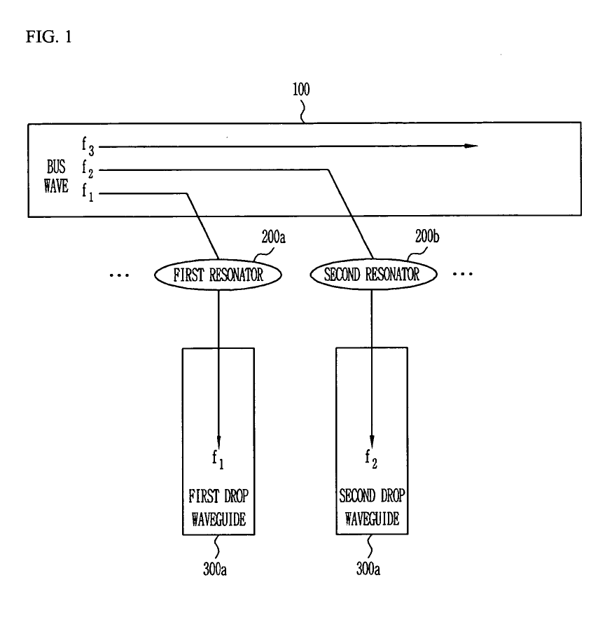

FIG. 1 is a schematic diagram illustrating a multi-channel drop filter using a photonic crystal according to an embodiment of the present invention.

As shown in FIG. 1, in the case that light having three frequencies (f₁, f₂, f₃) is guided along one bus waveguide 100, the light having a frequency of f₁ is dropped to a first drop waveguide 300a through a first resonator 200a, and the light having a frequency of f₂ is dropped to a second drop waveguide 300b through a second resonator 200b.

With this principle, light of all frequencies or wavelengths guided along the bus waveguide 100 can be filtered to different drop waveguides from each other 300a and 300b.

In addition, filtering light having a desired wavelength among various wavelengths guided along the bus waveguide 100 toward a desired drop waveguide is based on interaction between a guiding mode of the waveguide and a resonant mode of the resonator.

In other words, when the waveguide is arranged near the resonator, an evanescent wave of the guiding mode and an evanescent wave of the resonant mode overlap in a region between the waveguide and the resonator so that coupling between the modes occurs. In addition, in the case that a wavelength of the mode guided along the bus waveguide and a wavelength of the resonant mode are the same, photonic energy propagating along the bus waveguide is transferred to the resonator and the transferred energy is transferred again to the adjacent drop waveguide, due to strong coupling between the two modes. As a result, the light input to the bus waveguide is output to the drop waveguide via the resonator.

Accordingly, the dropped wavelength is determined by the wavelength of the resonant mode of the resonator. In other words, since the wavelength of the resonant mode depends on a structure of the resonator, the dropped wavelength can be tuned to a desired wavelength by properly designing the structure of the resonator.

In addition, a band of a light wavelength is selected to achieve the efficiency of design of the multi-channel drop filter operating in the optical communication region, and then a photonic band gap (PBG) region is obtained using a plane-wave expansion (PWE) method in order to have the large PBG structure at this band.

Next, the waveguide by a line defect and having a wide guiding mode in the PBG is illuminated so that the bus waveguide and the drop waveguide are designed. Through this design process, the structure and lattice constant of the photonic crystal, a dielectric rod or a radius of a hole are determined.

In addition, after determining the desired wavelength to be dropped, the resonator, where the resonant mode corresponds to the wavelength, by the point defect is designed. Finite-difference Time-domain (FDTD) simulation is performed to the designed structure, so that the wavelength and the intensity output to the drop waveguide from the bus waveguide via the resonator are estimated. Then, a distance among the bus waveguide, the drop waveguide and the resonator is adjusted so that the design value is optimized.

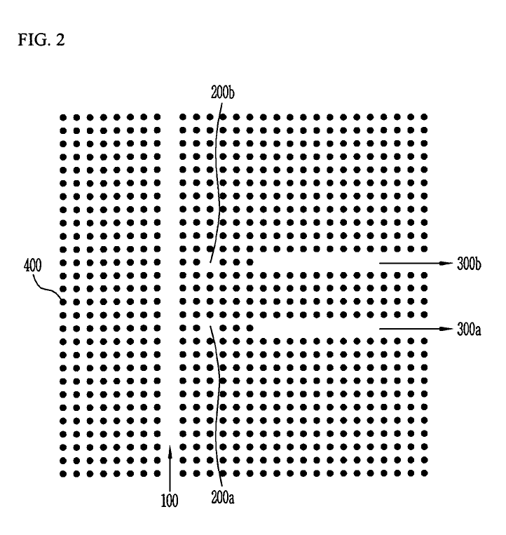

FIG. 2 is a diagram illustrating a two-channel drop filter using a photonic crystal according to an embodiment of the present invention. Although the two-channel drop filter is described in the present invention, other channel drop filters such as three-channel, four-channel, five-channel drop filters and the like can also be implemented.

As shown in FIG. 2, in the two-channel drop filter according to an embodiment of the present invention, a plurality of silicon rods 400 are periodically arranged in a two-dimensional photonic crystal square lattice structure. Here, by removing one of lines among the periodic silicon rods 400, i.e., by a line defect, a bus waveguide 100 is formed. Further, a pair of drop waveguides, i.e., first and second drop waveguide 300a and 300b are formed by removing two lines among the silicon rods 400 perpendicular to and near the bus waveguide 100, i.e., by line defects.

In addition, a first resonator 200a is formed by removing any one of the silicon rods 400 between the bus waveguide 100 and the first drop waveguide 300a, i.e., by a point defect. Further, a second resonator 200b is formed by reducing a radius of any one of the silicon rods 400 between the bus waveguide 100 and the second drop waveguide 300b, i.e., by a point defect.

Further, although the two-channel drop filter according to the embodiment of the present invention is implemented in the two-dimensional photonic crystal square lattice structure where the plurality of silicon rods 400 are periodically arranged, the present invention is not limited thereto, and it can be implemented in a planar photonic crystal fabricated by periodically boring a hole in a dielectric thin film.

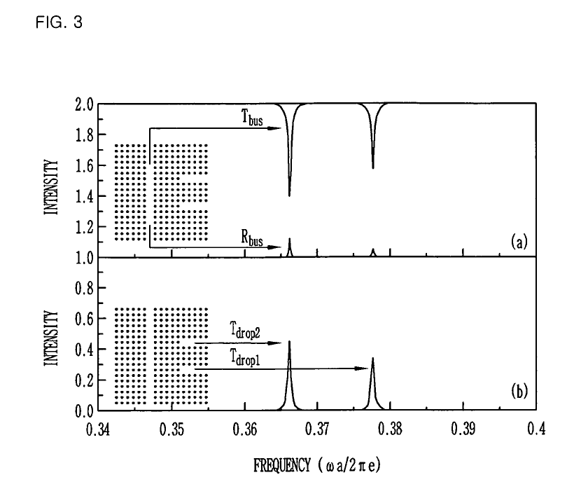

FIG. 3 is a diagram illustrating reflection and transmission characteristics of a bus waveguide and transmission characteristics of a drop waveguides in a two-channel drop filter using a photonic crystal according to an embodiment of the present invention.

As shown in FIG. 3, which is an example showing an operation of the multi-channel drop filter according to the present invention, an FDTD simulation results with respect to the reflection and transmission characteristics R_{bus} and T_{bus} of the bus waveguide 100 and the transmission characteristics T_{drop1} and T_{drop2} of each drop waveguide 300a and 300b in the two-channel drop filter shown in FIG. 2 are illustrated.

In other words, assuming the period of the square lattice is ‘a’, the radius of the silicon rod 400 is 0.2a, the radius of the point defect of the first resonator 200a is 0, and the point defect of the second resonator 200b is 0.1a.

In the case that the period ‘a’ is 0.55 μm, the wavelength of light guided to the first drop waveguide 300a is 1.5 μm, and the wavelength of light guided to the second drop waveguide 300b is 1.46 μm. Further, the overall size of the filter shown in FIG. 2 is about 15 μm×15 μm, which is very small compared to the existing filter.

As described above, the present invention is directed to a multi-channel drop filter selecting light having a desired wavelength using a planar photonic crystal to filter the respective one in a direction perpendicular to the propagating direction. In the planar photonic crystal having dielectric rods periodically arranged or holes periodically bored in the dielectric thin film, light having a desired wavelength among light of various wavelengths guided along the bus wavelength is filtered through at least one resonator arranged between the bus waveguide and the drop waveguide, to the drop waveguide arranged perpendicular to the bus waveguide, thereby capable of being easily connected to the existing planar photonic crystal devices to enable fabrication by nanoimprint technology using an embossing process and to allow mass production at low costs as well as implementing an optical filter having an ultra narrowband line width and a high integrated photonic integrated circuit.

As described above, according to a multi-channel drop filter using a photonic crystal of the present invention, a plurality of drop waveguides are formed in a direction perpendicular to and near a bus waveguide formed by a line defect within a photonic crystal, and at least one resonator by a point detect between the bus and drop waveguides are formed to filter light having a desired wavelength among light of various wavelengths guided along the bus wavelength to the drop waveguide arranged perpendicular to the bus waveguide through the resonator arranged between the bus and drop waveguides, thereby capable of being easily connected to the existing planar photonic crystal devices to enable fabrication by nanoimprint technology using an embossing process and to allow mass production at low costs as well as implementing an optical filter having an ultra narrowband line width and a high integrated photonic integrated circuit.

While the multi-channel drop filter using a photonic crystal according to the present invention has been described with reference to exemplary embodiments, these embodiments are illustrative only, but not for limiting the scope of the present invention claimed in the following claims. Therefore, those skilled in the art will appreciate that a variety of modifications can be made within the appended claims, the detailed description of the invention, and the accompanying drawings, which can also be included in the present invention.

1. A multi-channel drop filter using a photonic crystal, comprising:
a bus waveguide formed in a photonic crystal;
at least one drop waveguide arranged substantially perpendicular to the bus waveguide; and
at least one resonator arranged between the bus waveguide and the drop waveguide to independently filter light having a desired wavelength among light of various wavelengths guided along the bus waveguide to the desired drop waveguide.

2. The multi-channel drop filter according to claim 1, wherein the bus waveguide and the drop waveguide are formed by line defects.

3. The multi-channel drop filter according to claim 1, wherein the resonator is formed by point defects.

4. The multi-channel drop filter according to claim 2, wherein the resonator is formed by point defects.
